(19) United States
(12) Patent Application Publication
(10) Pub. No.: US 2012/0312935 A1
(43) Pub. Date: Dec. 13, 2012

(54) BABY BOTTLE HOLDER

(76) Inventor: Debra Kaufman, Great Neck, NY (US)

(21) Appl. No.: 13/159,072

(22) Filed: Jun. 13, 2011

(51) Int. Cl. A61J 9/06; A47D 15/00

(52) U.S. Cl. 248/104; 248/103

(57) ABSTRACT

A baby bottle holder for use with an infant carrier including a sleeve, configured to hold a baby bottle, a support strap having a width of less than an infant pupillary distance, and a pair of constraining straps each secured to opposite sides of the sleeve. The support strap and pair of constraining straps are attached to the sleeve such that, when linearly extended outwards from the sleeve, they will substantially form one of an inverted letter “T”-shape configuration or inverted letter “Y”-shape configuration, with the stem of the letter being formed by the support strap and the arms of the letter being formed by the constraining straps.

### BACKGROUND

1. Field

This application generally relates to supports and, more particularly, supports for baby bottles.

2. Background

Baby bottle supports are generally used to allow a baby who lacks the capability or dexterity to hold a baby bottle and feed themselves to nevertheless feed while unattended. However, each type has certain drawbacks. For example, the support of U.S. Pat. No. 7,213,791 is free-swinging, so it can allow an infant to be hit by a swinging bottle and, in use, it blocks a substantial portion of the infant from view. The baby bottle support of U.S. Pat. No. 6,601,803 and U.S. Published Pat. Application No. 2010/0224739 allow the bottle to freely twist about the horizontal such that, if the nipple of the bottle comes out of the baby's mouth, the nipple end of bottle will inevitably pivot up or down impeding or eliminating the ability of the baby to resume feeding without adult intervention.

### BRIEF SUMMARY

In one aspect of this disclosure, a baby bottle holder is disclosed, for use with an infant carrier having a body portion having first and second sides between which an infant may be placed. The baby bottle holder includes a sleeve, configured to constrain the outer periphery of a baby bottle inserted therewithin, a support strap having a width of less than an infant pupillary distance, a first end secured to the sleeve, and a second end configured to releasably secure the sleeve to the infant carrier above the sleeve, and a pair of constraining straps each having a first end secured to opposite sides of the sleeve and a second end configured to secure the respective constraining strap near the respective sides of the infant carrier. The support strap and pair of constraining straps are attached to the sleeve at their first ends such that, when linearly extended outwards from the sleeve, they will substantially form one of an inverted letter “T”-shape configuration or inverted letter “Y”-shape configuration, with the stem of the letter being formed by the support strap and the arms of the letter being formed by the constraining straps.

Another aspect of this disclosure involves at least two attachment points on the sleeve to which the support strap can be adjustably secured to alter orientation of a bottle within the sleeve relative to an infant to be fed.

Another aspect of this disclosure involves securing devices on ends of the support strap and pair of constraining straps.

A further aspect of this disclosure involves one or more of the securing devices including at least one of: a hook and loop fastener, a clasp buckle, a slide buckle, a side release buckle, a cam-type buckle, a ladder lock buckle, a snap fastener, a clasp or a clip.

Still another aspect of this disclosure involves the width of the support strap being less than about 45 mm.

Another aspect of this disclosure involves the width of the support strap being between about 45 mm and about 30 mm.

Yet another aspect of this disclosure involves the width of the support strap is less than about 30 mm.

Another aspect of this disclosure involves the support strap including a woven material.

Another aspect of this disclosure involves the woven material including cloth.

An additional aspect of this disclosure involves the support strap including a polymer.

Another aspect of this disclosure involves the constraining straps each having a maximum width substantially equal to the width of the support strap.

Another aspect of this disclosure involves the constraining straps being substantially, dimensionally identical to each other.

Another aspect of this disclosure involves the constraining straps being substantially mirror images of each other.

Another aspect of this disclosure involves a pattern of graphics on a side of the support strap that will face a feeding infant when the baby bottle holder is in use.

Another aspect of this disclosure involves the support strap including a clear material.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a simplified side view of an exemplary implementation of my baby bottle holder;

FIG. 2 is a simplified side view of another exemplary implementation of my baby bottle holder;

FIG. 3 is a simplified side view of still another exemplary implementation of my baby bottle holder;

FIGS. 4-5 are simplified end views of baby bottle holders similar to the example holders of FIGS. 1 through 3 but have slightly different configurations;

FIG. 6 is a simplified view of the exemplary baby bottle holders of FIG. 4 or FIG. 5 installed on an infant carrier of the type that can also double as a car seat;

FIG. 7 is a front view of the infant carrier and baby bottle holder of FIG. 6, but with a representation of an infant situated therein; and

FIG. 8 is a front view of a portion of an exemplary baby bottle holder with a support strap that includes a transparent section.

### DETAILED DESCRIPTION

This application discloses a baby bottle holder having numerous advantages over the prior art. The disclosed baby bottle holder uses three straps to secure it to an infant carrier. Note that, as used herein, the term “infant carrier” means, and is generically intended to refer to and encompass, stand alone infant carrier seats that generally include a swivel-able handle for carrying, similar seats that also double as car seats, as well as infant bouncy seats, carriages and strollers that include a sun shade or other overhead appendage to which one of the straps is to be attached and structures on either side of where the infant will be located to which the other two straps can be attached, or any other type of infant carrier that has similarly placed components to which the various straps can be connected in the manner and configuration described herein.

The first support strap attaches to the overhead handle or sun shade of the infant carrier and is narrower than the pupillary width of most infants to ensure that the caregiver's and infant's fields of vision of each other are not impeded. The narrow strap also insures that the caregiver's ability to access the infant is minimally impacted. The remaining two straps are constraining straps and attach to the side struts or handle of the infant carrier or the body of the infant carrier at or below the level of the baby bottle itself. Any or all of the three straps may be length-adjustable. As a result, depending on the configuration, the baby bottle holder may be adjusted vertically, horizontally and (to some limited extent) towards or away from the infant. The configuration of the straps also stabilizes the baby bottle holder, preventing it from undue swinging and hitting the infant's face.

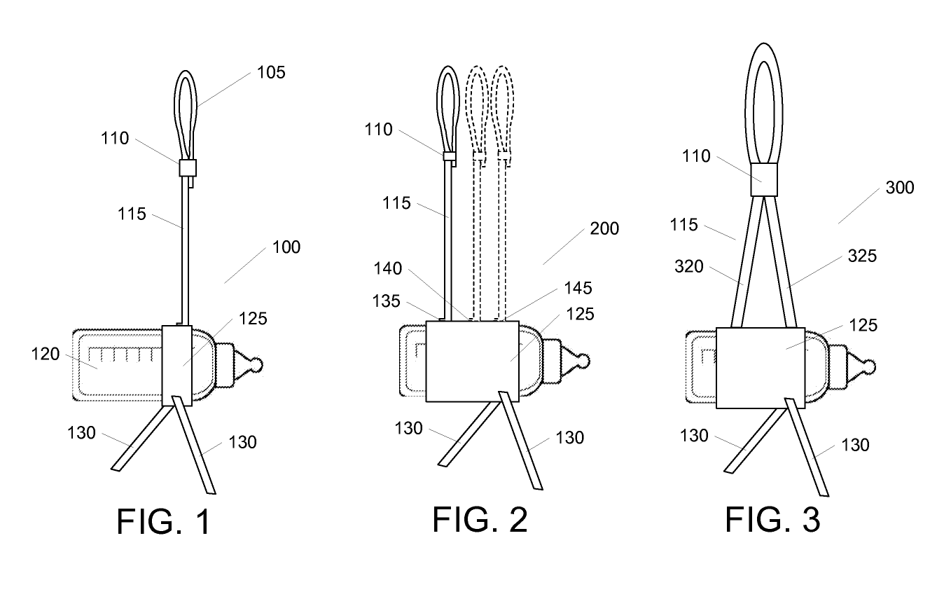

FIG. 1 is a simplified side view of an exemplary implementation of the baby bottle holder 100. The baby bottle holder 100 includes a baby bottle sleeve 125 that holds the baby 120. The sleeve 125 is made to removably constrain a baby bottle within it and may be made from any lightweight material capable of doing so, which may include an elastic material to enable the sleeve 125 to conform to different shaped bottles or a specific shape that is the negative image of a particular bottle shape.

A support strap 115 and two constraining straps 130 are attached to the sleeve 125 either permanently or removably, for example, by stitching, gluing, plastic welding, or other suitable permanent affixation approaches, or using rings, clips, buckles, or other removable connectors, or any other suitable known approach for joining or connecting the two components. The support strap 115 and the constraining straps 130 may be made of any combination of a cloth, a woven or a sheet material, such as (but not limited to) cotton, plastic or polymer cloth or other flexible material. Advantageously, the use of cloth or other flexible sheet material allows the baby bottle holders described herein to be collapsed into a small space, making them light and easily transportable.

The support strap 115 couples the baby bottle sleeve 125 to an upper supporting structure, such as, for example, the handle, canopy, canopy frame, sun shade or sun shade frame of an infant carrier, thereby supporting the weight of the baby bottle 120. The support strap 115 may be coupled to the infant carrier by, for example, a loop 105 and fastener mechanism 110. Variations on the fastener mechanism 110 may include a snap fastener, clasp buckle, slide buckle, side release buckle, cam-type buckle, ladder lock buckle, clip, clamp, hook and loop fastener (for example, as sold under the trademark Velcro®), or any other fastener appropriate for creating the securing the loop 105. Alternatively, the loop can be replaced, in some implementations, by a hook, clip or clamp. The support strap 115 is preferably length adjustable. In one embodiment, the overall length of the support strap 115 is controlled by the fastener mechanism 110. Drawing more length of the support strap 115 through the fastener mechanism 110 shortens an overall length of the support strap 115, thereby raising the baby bottle holder 100 relative to the infant, doing the opposite lowers the baby bottle holder 100. Other height adjusting mechanisms may be utilized as appropriate.

The support strap 115 preferably has a width less than a general infant pupillary distance, which is generally less than about 45 mm, typically between about 45 mm and about 30 mm. Thus, the width will preferably be less than about 45 mm, typically within the range of about 30 mm to about 45 mm wide. Optionally, the support strap 115 can include graphics on the side that faces the infant to provide the infant with something to attract/hold their attention. In addition, the support strap 115 can be clear/transparent over a portion as described in greater detail below, to provide a still less obstructed view.

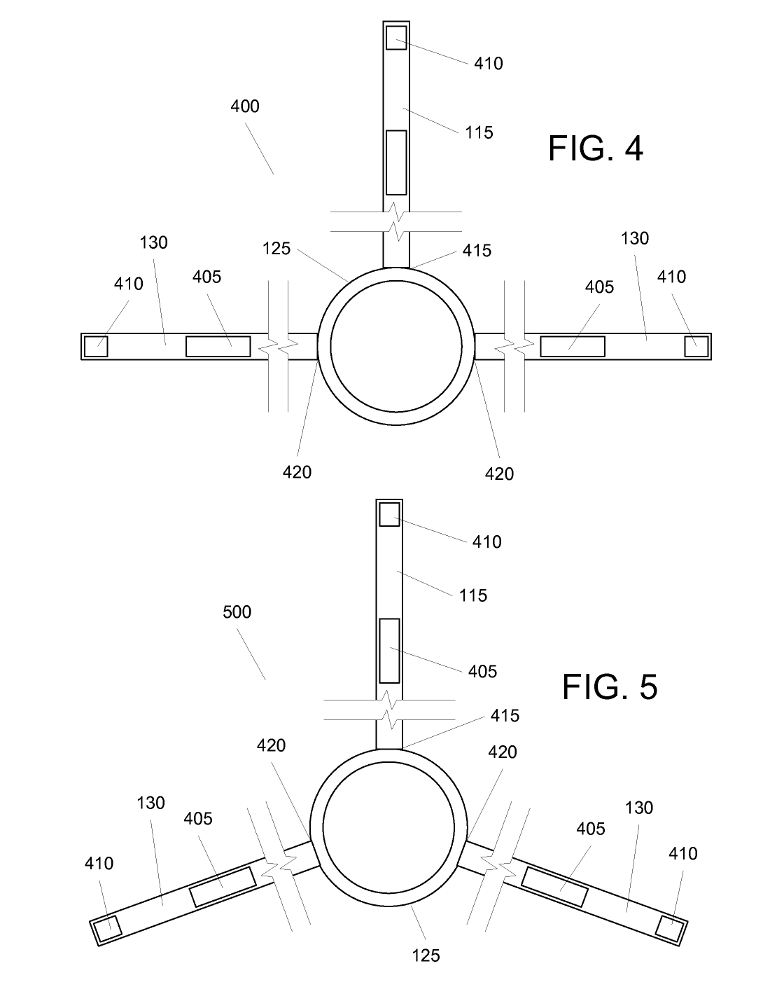

The constraining straps 130 can likewise be formed of any of the materials suitable for use as the support strap 115. The width of the constraining straps 130 is less important, but will typically have a width within the acceptable range for the support strap 115, but could alternatively be wider or narrower. In some implementations, the constraining straps 130 may be substantially identical from a dimensional point of view or may be substantially mirror images of each other, however, neither is a requirement. The constraining straps 130 are used to secure the baby bottle holder 100 to other locations on the infant carrier. For example, the constraining straps 130 may have a similar loop and fastener mechanism as the support strap 115, enabling them to couple to the vertical portions of an infant carrier handle or frame, thereby forming an inverted, predominantly letter “T”-shaped configuration (such as depicted in FIG. 4) or letter “Y”-shaped configuration (such as depicted in FIG. 5) where the support strap 115 would correspond to the stem of the letter and the constraining straps 130 would correspond to the arms of the letter. Alternatively, the constraining straps 130 may attach to pre-defined or pre-installed mating surfaces or components on the body of the infant carrier.

Depending upon the particular implementation, attachment of the support strap 115 and constraining straps 130 to the sleeve 125 is such that, when linearly extended normal to their respective connection points on the sleeve 125, they will lie in a common plane. Alternatively, they can be configured, as described below, such that, when linearly extended normal to their respective connection points on the sleeve 125, the constraining straps 130 will lie in a different plane than the support strap 115, and those planes may, or may not, be parallel to each other.

FIG. 2 is a simplified side view of another exemplary implementation of the baby bottle holder 200. As shown, the baby bottle sleeve 125 of this holder 200 is designed to allow the support strap 115 to couple to any of a number of attachment positions, for example, along its length or at some discrete positions 135, 140 and 145 along that length. This would allow for further adjustment of a pivot angle (i.e., orientation in space) of the baby bottle 120 relative to the baby via modification of the attachment point. It is understood that FIG. 2 is illustrative, and the particular attachment positions displayed are for purposes of explanation and brevity only and any number of attachment positions may be utilized. Furthermore, with variations of this example implementation, a continuous attachment surface can be provided such that the attachment positions 135, 140 and 145 may be selected to be anywhere along the continuous attachment surface, using, for example, a slide or a strip of hook and loop fasteners, thereby allowing for greater freedom of adjustment.

FIG. 3 is a simplified side view of still another exemplary implementation of the baby bottle holder 300. With this implementation, the support strap 115 is made up of two support arms 315 which respectively attach to the baby bottle sleeve 125 at two different positions 320, 325 along the length direction of the baby bottle sleeve 125. As with the implementation of FIG. 2 above, this configuration would also allow adjustment of a pivot angle of the baby bottle 120 relative to the infant, with the degree of the pivot angle depending, in part, on the relative lengths of the support strap arms 150. The fastener mechanism 310 is similar to the fastener mechanism 115 described above, except that, with this embodiment, it allows both adjustment and fastening of the relative lengths of support arms 315.

FIGS. 4 and 5 are simplified end views of baby bottle holders 400, 500 similar to the illustrative holders of FIGS. 1-3, except these holders 400, 500 specifically use a fastener mechanism 110 of the hook and loop type made up of a hook portion 405 and a loop portion 410, or vice-versa, and each has a different configuration of the constraining straps 130 relative to the support strap 115. As shown in FIG. 4, the baby bottle holder 400 is made so that when the support strap 115 and the constraining straps 130 are fully linearly extended from their connection points 415, 420, normal to the baby bottle sleeve 125, the result will be that the baby bottle holder 400 will be configured in a “T”-shape (or inverted “T”-shape). As shown in FIG. 5, the baby bottle holder 500 is made so that when the support strap 115 and the constraining straps 130 are fully linearly extended from their connection points 415, 420, normal to the baby bottle sleeve 125, the result will be that the baby bottle holder 500 will be configured in a “Y”-shape (or inverted “Y”-shape).

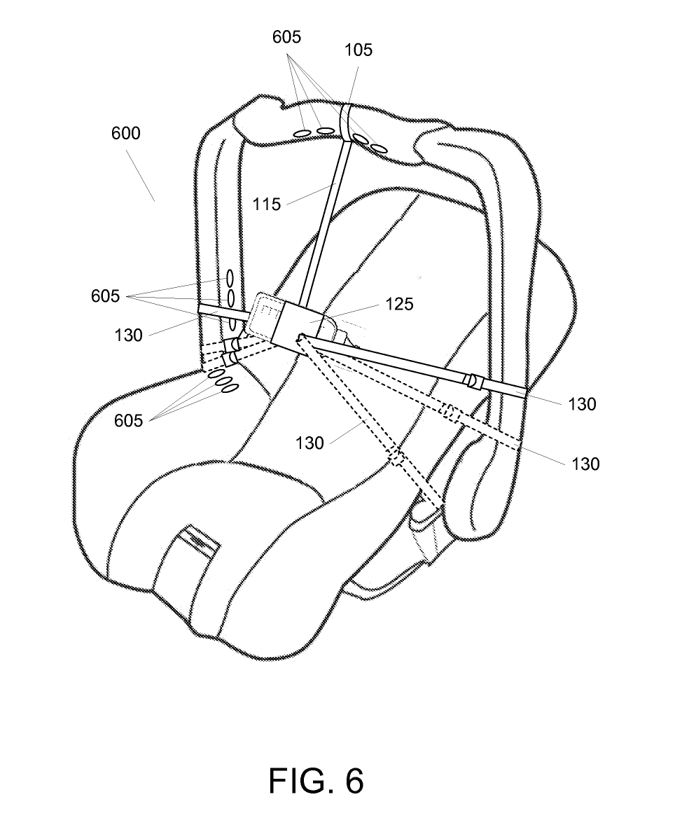

FIG. 6 is a simplified view of exemplary baby bottle holders 400, 500 of FIG. 4 or FIG. 5 installed on an infant carrier 600 of the type that can also double as a car seat. As described above and visible in FIG. 6, depending upon the particular implementation, the baby bottle holder when secured to the infant carrier, will be in either the inverted “T”-shaped configuration 400 of FIG. 4 or the inverted “Y”-shaped configuration 500 of FIG. 5.

Advantageously, to accommodate one or both of these types of baby bottle holders, the infant carrier may be equipped with their own attachment mechanisms at locations 605 on the infant carrier body (handle, support structure and/or base) to correspondingly mate with an attachment mechanisms 110, 405, 410 on the baby bottle holder to thereby make it easier to secure the constraining straps 130 and/or the support strap 115 to the infant carrier and potentially affect the orientation of the baby bottle 120 alone or, in the case of an embodiment like that shown in FIG. 2, in conjunction with the continuous or discrete attachment positions 135, 140 and 145 described above. Note that only those illustrative attachment mechanism locations 605 visible from this perspective are shown. It is to be understood that others would be present on the opposite side of the infant carrier, but would be obscured in this view.

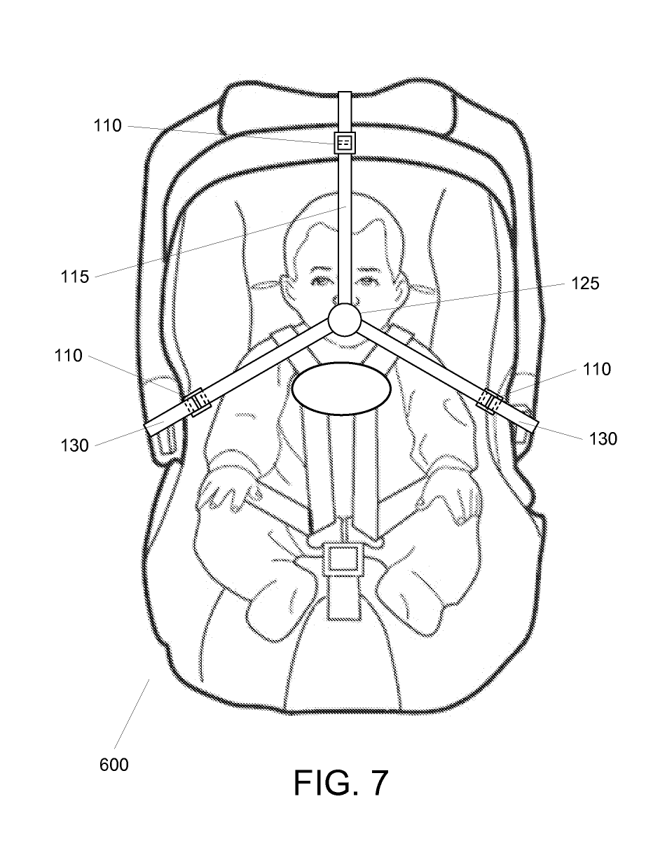

FIG. 7 is a front view of the infant carrier of FIG. 6, with a representation of an infant located therein to show that the support strap 115 width of less than the pupillary distance of the infant supports a baby bottle 120, but it does not fully obstruct the infant's view. Moreover, access to the infant is minimally impacted by the support strap 115 and constraining straps 130.

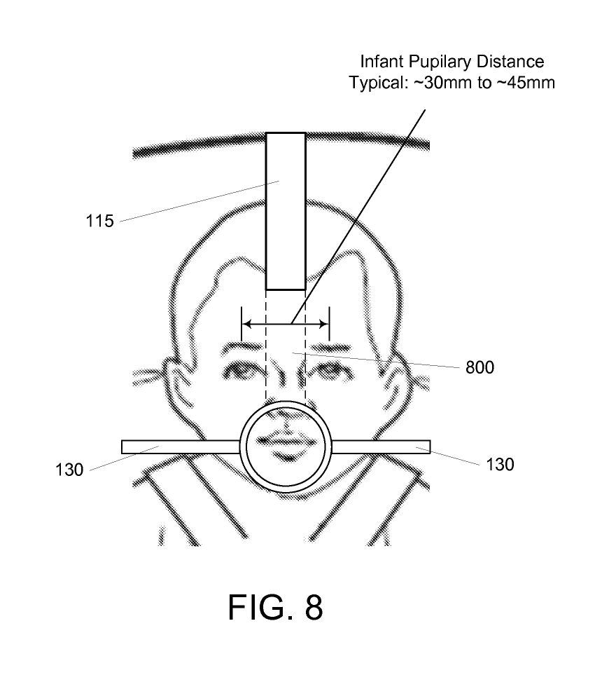

FIG. 8 is a front view of a portion of an exemplary baby bottle holder that is, in all respects similar to the baby bottle holders described above 100, 200, 300, 400, 500, except that the support strap 115 includes a section 800 of clear material (i.e., that is transparent). The transparent section 800 additionally, and advantageously, may be included as part of the support strap 115 to further minimize any unobstructed line of sight between the infant and the caretaker.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A baby bottle holder for use with an infant carrier having a body portion including first and second sides between which an infant may be placed, the baby bottle holder comprising:
a sleeve, configured to constrain the outer periphery of a baby bottle inserted therewithin;
a support strap having a width of less than an infant pupillary distance, a first end secured to the sleeve, and a second end configured to releasably secure the sleeve to the infant carrier above the sleeve; and
a pair of constraining straps each having a first end secured to opposite sides of the sleeve and a second end configured to secure the respective constraining strap near the respective sides of the infant carrier;
the support strap and pair of constraining straps being attached to the sleeve at their first ends such that, when linearly extended outwards from the sleeve, they will substantially form one of an inverted letter “T”-shape configuration or inverted letter “Y”-shape configuration, with the stem of the letter being formed by the support strap and the arms of the letter being formed by the constraining straps.

2. The baby bottle holder of claim 1, wherein when a baby bottle is inserted within the sleeve, the longitudinal axis of the baby bottle will define an axial direction for the sleeve, the baby bottle holder further comprising:
at least two attachment points on the sleeve along the axial direction to which the first end of the support strap can be adjustably secured to alter orientation of a bottle within the sleeve relative to an infant to be fed.

3. The baby bottle holder of claim 1, further comprising securing devices on each of the second ends of the support strap and pair of constraining straps.

4. The baby bottle holder of claim 3, wherein at least one of the securing devices comprises at least one of a hook and loop fastener, a clasp buckle, a slide buckle, a side release buckle, a cam-type buckle, a ladder lock buckle, a snap fastener, a clasp or a clip.

5. The baby bottle holder of claim 1, wherein the width is less than about 45 mm.

6. The baby bottle holder of claim 5, wherein the width is between about 45 mm and about 30 mm.

7. The baby bottle holder of claim 5, wherein the width is less than about 30 mm.

8. The baby bottle holder of claim 1, wherein the support strap comprises a woven material.

9. The baby bottle holder of claim 5, wherein the woven material comprises cloth.

10. The baby bottle holder of claim 1, wherein the support strap comprises a polymer.

11. The baby bottle holder of claim 1, wherein the constraining straps each have a maximum width substantially equal to the width of the support strap.

12. The baby bottle holder of claim 1, wherein the constraining straps are substantially, dimensionally identical to each other.

13. The baby bottle holder of claim 1, wherein the constraining straps are substantially mirror images of each other.

14. The baby bottle holder of claim 1, wherein the support strap comprises a clear material.

15. The baby bottle holder of claim 1, further comprising a pattern of graphics on a side of the support strap that will face a feeding infant when the baby bottle holder is in use.

16. An apparatus for supporting a baby bottle on an infant carrier during feeding of an infant comprising:
means for holding the baby bottle;
non-obstructing, narrow means, coupled to the means for holding, for supporting the baby bottle from a supporting structure on the infant carrier in a vertical direction; and
constraining means, coupled to the means for holding, for constraining movement of the means for holding relative to sides of the infant carrier;
wherein the non-obstructing, narrow means and constraining means are oriented relative to each other by their respective coupling to the means for holding in one of a “T” or “Y” shape configuration.

17. The apparatus of claim 16, further comprising:
means for adjusting a length of the non-obstructing, narrow means.

18. The apparatus of claim 17, further comprising:
means for adjusting a constraining means length.

19. The apparatus of claim 16, wherein the non-obstructing, narrow means comprises a transparent area.

20. The apparatus of claim 16, wherein the non-obstructing, narrow means is coupled to the means for holding via means, along a length of the means for holding, for adjusting a coupling location for the non-obstructing, narrow means and affecting baby bottle orientation.
